(19) United States
(12) Patent Application Publication
(10) Pub. No.: US 2013/0268940 A1
(43) Pub. Date: Oct. 10, 2013

(54) AUTOMATING WORKLOAD VIRTUALIZATION

(71) Applicants: Daniel Juergen Gmach, Palo Alto, CA (US); Jerome Rolla, Kanata (CA); Ludmila Cherkasova, Sunnyvale, CA (US)

(72) Inventors: Daniel Juergen Gmach, Palo Alto, CA (US); Jerome Rolla, Kanata (CA); Ludmila Cherkasova, Sunnyvale, CA (US)

(21) Appl. No.: 13/439,410

(22) Filed: Apr. 4, 2012

(51) Int. Cl. G06F 9/46

(52) U.S. Cl. 718/104

(57) ABSTRACT

A system, and a corresponding method enabled by and implemented on that system, automatically calculates and compares costs for hosting workloads in virtualized or non-virtualized platforms. The system allows a service user (i.e., a customer) to decide how best to have workloads hosted by apportioning costs that are least sensitive to workload placement decisions and by providing robust and repeatable cost estimates. The system compares the costs of hosting a workload in virtualized and non-virtualized environments; separates workloads into categories including those that should be virtualized and those that should not, and determines the amount of physical resources to cost-effectively host a set of workloads.

### BACKGROUND

Virtualization schemes are used in many computing environments. Such schemes are used, for example, in private and public cloud computing environments for virtualizing customer workloads among shared data storage and processing resources. A workload may be, for example, a software application or process that is supported by a computing system. Customers typically pay for their use of these shared resources on a per workload basis.

Cloud computing belongs to the broader concept of infrastructure convergence and shared service and resource pools. Cloud computing is the delivery of computing as a service rather than a product. In cloud computing environments, shared resources, software, and information are provided to customer devices as a utility over a network, typically the Internet. Cloud computing provides computation, software applications, data access, data management, and storage resources without requiring customers to know the location and other details of the cloud computing infrastructure. Customers access the cloud computing infrastructure through a web browser or a light weight desktop or mobile application.

### DESCRIPTION OF THE DRAWINGS

The detailed description will refer to the following drawings in which like numerals refer to like objects, and in which:

FIG. 1 illustrates an embodiment of an environment in which customer workloads are hosted in a shared resource pool;

FIG. 2 illustrates a system usable in the environment of FIG. 1 to generate virtualization alternatives for hosting customer workloads; and

FIG. 3 is a flow chart illustrating an embodiment of a method for assigning workloads in the embodiment of FIG. 1.

### DETAILED DESCRIPTION

Disclosed herein is a system, and a corresponding method enabled by and implemented on that system, that automatically, and dynamically, calculates and compares costs for hosting workloads in virtualized or non-virtualized physical machines. The cost data produced by the system allows a customer and/or a service provider to decide how best to host workloads on the physical machines. Alternately, the hosting decision may be made automatically based on preset criteria. The system and method can be used for initial workload hosting decisions and/or subsequent rehosting decisions if conditions, such as server availability and workload performance requirements, for example, change.

Virtualization schemes are used in many computing environments. Such schemes are used, for example, in cloud computing environments for spreading customer workloads among, shared data storage and processing resources.

Cloud computing environments can take many different forms, but most such environments involve some form of virtualization: rather than assigning applications to physical machines, he cloud computing environment creates and manages a number of virtual machines that are hosted on the physical machines. The advantages of virtualization will be discussed briefly below; the cost allocation problems raised by virtualization will be described in more detail.

In a public cloud, applications, storage, and other resources are made available to the general public by, a service provider. Public cloud services may be free or offered on a pay-per-usage model. The cloud service provider owns or leases all the infrastructure at its data center and access to this data center typically is through the Internet only.

A community cloud shares infrastructure between several organizations from a specific community with common concerns (security, compliance, jurisdiction, etc.). Whether managed internally or by a third-party and hosted internally or externally, the costs are spread over fewer users than a public cloud (but more than a private cloud), so only some of the cost savings potential of cloud computing may be realized.

A private cloud is infrastructure operated solely for a single organization, whether managed internally or by a third-party and hosted internally or externally.

A hybrid cloud is a composition of two or more clouds (private, community or public) that remain unique entitles but are bound together, offering the benefits of multiple deployment models.

The cloud service may offer several possible support models for use by its clients. In one such model, the cloud service provides computing platforms as physical, or more often as virtual machines, raw (block) storage, firewalls, load balancers, and networks. These resources are offered on demand from large resource pools. Local area networks including IP addresses may be part of the offer. For the wide area connectivity, the Internet can be used or, in some clouds, dedicated virtual private networks can be configured.

In another model, cloud service providers deliver a computing platform and/or solution stack typically including operating system, programming language execution environment, database, and web server. Application developers can develop and run their software solutions on a cloud platform without the cost and complexity of buying and managing the underlying hardware and software layers. The underlying compute and storage resources scale automatically to match application demand such that the client does not have to allocate resources manually.

In yet another model, cloud service providers install and operate application software in the cloud and cloud clients access the software from their local machines The clients do not manage the cloud infrastructure and platform on which the application is running. This model eliminates the need to install and run the application on the client's own computers, thereby simplifying maintenance and support.

What makes a cloud application different from other applications is its elasticity, which can be achieved by cloning tasks onto multiple virtual machines at run-time to meet the changing work demand. Load balancers distribute the work over the set of virtual machines. This process is transparent to the client, who sees only a single access point. To accommodate a large number of clients, cloud applications can be multitenant, that, is, any machine serves more than one client

Virtualization offers a customer the potential for cost-effective service provisioning. However service providers who make significant investments in new virtualized data centers in support of private or public clouds face the serious challenge of recovering costs (i.e., chargeback) for new server hardware, software, network, storage, and management, for example. Gaining visibility and accurately determining the cost of shared resource usage is part of implementing a proper chargeback approach in cloud computing, or shared resource, environments.

Before the widespread adoption of virtualization, the accounting model for shared resource usage considered the server hardware, its power usage, and software costs, which then were directly associated with the deployed application using these resources, while the storage and networking costs were typically apportioned on a usage basis. However, when multiple virtual machines with different resource requirements are deployed to a resource pool and when the virtual machines may be frequently reassigned to different physical servers, the cost allocation becomes more difficult.

One possible approach for establishing the cost of providing a cloud service is to extend the usage-based model, i.e., from virtualization layer for a costing interval, e.g., three weeks, and then the physical server costs can be split up respectively. Currently, many service providers employ such simplified usage-based accounting models. However, the relationship between workloads and costs is complex, and this simplified model may not reflect costs accurately. Some workloads may have a large peak to mean ratio for demands upon server resources. Such workloads are referred to herein as bursty. For example, a workload may have a peak CPU demand of 5 CPU cores but a mean demand of 0.5 of a CPU core. Such ratios may have an impact on shared resource pools. A pool that aims to consistently satisfy the demands of bursty workloads may have to limit the number of workloads assigned to each server, which affects the number of servers needed for a resource pool. Thus, burstiness affects costs. Further, server resources are rarely fully utilized even when workloads are tightly consolidated and all servers are needed. Even though many services can be assigned to a server, some portion of the resources remain unused over time. The amount of unused resources may depend on workload placement/consolidation choices and these choices may change frequently. The costs of such unused resources may be apportioned across workloads.

The many problems noted above with respect to hosting workloads are addressed by the herein disclosed system and method. The system uses workload hosting models to either decide whether to virtualize, or to support the decision to virtualize, and optimizes the physical resource pool based on such virtualization decisions. More specifically, the system compares the costs of hosting a workload in virtualized and non-virtualized environments, and separates workloads into categories such as those workloads that should be virtualized and those that should not. For workloads that should be virtualized, the system determines the “right-virtualization” scheme; i.e., what virtualization solution will provide the optimum cost structure for the workload. For example, right virtualization may involve moving a workload to a physical machine/virtual machine combination outside the shared resource pool. Finally, the system determines the amount and identity of physical resources required to most cost-effectively host a set of workloads, since some workloads may cost more to host using certain virtualization platforms than on other virtualization platforms, or on standalone (i.e., non-virtualized) physical machines. For example, the identified workloads can be hosted directly on dedicated physical machines or using virtualization platforms with lower or no licensing fees. More specifically, a workload could be less expensively deployed to a server virtualized with a hypervisor, or a server running an open-source virtualization technology such as Kernel-Based Virtualization Machine (KVM), a virtualization infrastructure for the Linux kernel, or Xen, a virtual-machine monitor providing service that allows multiple computer operating systems to execute on the same computer hardware concurrently. Both KVM and Xen are subject to a GNU general public license (GPL) license fee.

The system and method may be used in both private and public shared resource environments. That is, the system and method may be used in private and public cloud computing environments, or in any environment in which workloads may be shared among data processing and storage resources. In a public setting, the customers may be unrelated to the virtualization service provider and are charged fees for the provided virtualization services. In a private setting, the customers may be business units of a larger company, and are allocated costs against their operating budgets based on their use of the provided virtualization services. In either the public or private environments, the virtualization service provider is able to reduce costs and to allocate those reduced costs equitably and accurately using the herein disclosed system and method.

The system, and corresponding method, takes into account the configuration of hosts and the time varying demands of workloads, i.e., resource usage traces of the workload over time. The costs-per-host may include the host list price, license and maintenance fees for a virtualization solution, and power usage by the host physical machine. Prices may be obtained by amortizing the costs of the physical machines and virtualization programs, and power usage information from estimates or actual monitored power usage by the physical machines that operate as the virtualization hosts. The amortization period may be chosen to conform to the expected useful service life of either or both the physical machine and the virtualization program, which may be, for example, three years. The time varying demands of workloads are customer specific.

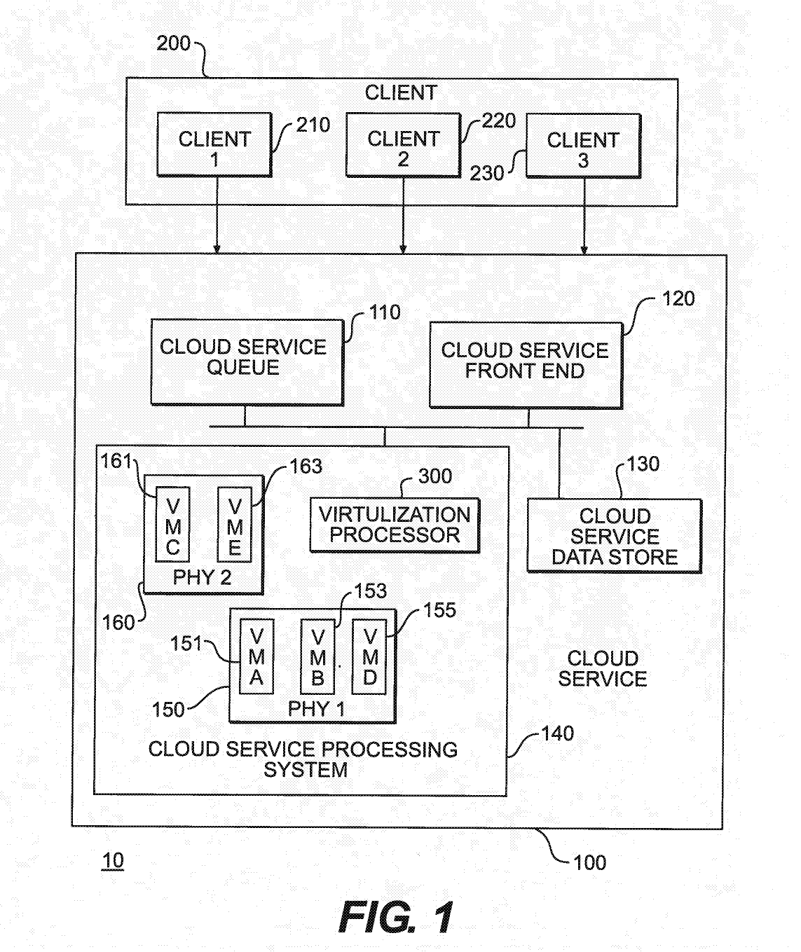

FIG. 1 illustrates an embodiment of an environment in which customer workloads are hosted in a shared resource pool. In FIG. 1, environment 10 includes private cloud service 100 that is managed by a cloud service provider on behalf of, or to service, the data processing and storage needs of client 200. The cloud service 100 includes cloud service queue 110, cloud service front end 120, cloud service data store 130, and cloud service processor system 140.

The client 200 includes client units 210, 220, and 230. Each client unit ay be a separate cost center of the client 200. Each client unit may include a number of devices that are used to interact with the cloud service 100. For example, client unit 230 includes a laptop computer, a desktop computer, a server, a smart phone, and a tablet.

The cloud service queue 110 receives workloads from the client 200 and processes the workloads for eventual distribution to one or more of the host physical machines in the cloud service 100. Workloads may be held in the queue 110 until a host physical machine can be, and is, assigned to the workload. The cloud service front end 120 controls operation of the cloud service 100, and presents a user interface (not shown) for administrators of the cloud service 100 and for client administrators who may interact with the cloud service 100. The cloud service front end 120 executes programming and logic (i.e., machine instructions) to operate the cloud service 100, including the components of the cloud service processing system 140.

The cloud service data store 130 provides data storage features, including physical data storage devices such as data servers, hard drives, and removable storage devices, the databases and database management systems that reside on these devices, and the communications network, or data buses that couple these data store devices to other hardware components of the cloud service 100.

The cloud service processing system 140 includes physical machines such as servers, virtualization programs to create and manage virtual machines, and to allocate workloads to physical machines and to virtual machines, cost and billing programs to determine charge backs to the client 200 for services, and other related software programs, and memory to store data and programming executed on the physical machines. As shown in FIG. 1, the cloud service processing system 140 includes physical machines 150 and 160, and virtualization processor system 300. The machine 150 is shown operating with three hosted virtual machines 151 (VM-A), 153 (VM-B), and 155 (VM-D). The machine 160 includes virtual machines 161 (VM-C) and 163 (VM-E). More or fewer virtual machines could be hosted on each of the physical machines 150 and 160.

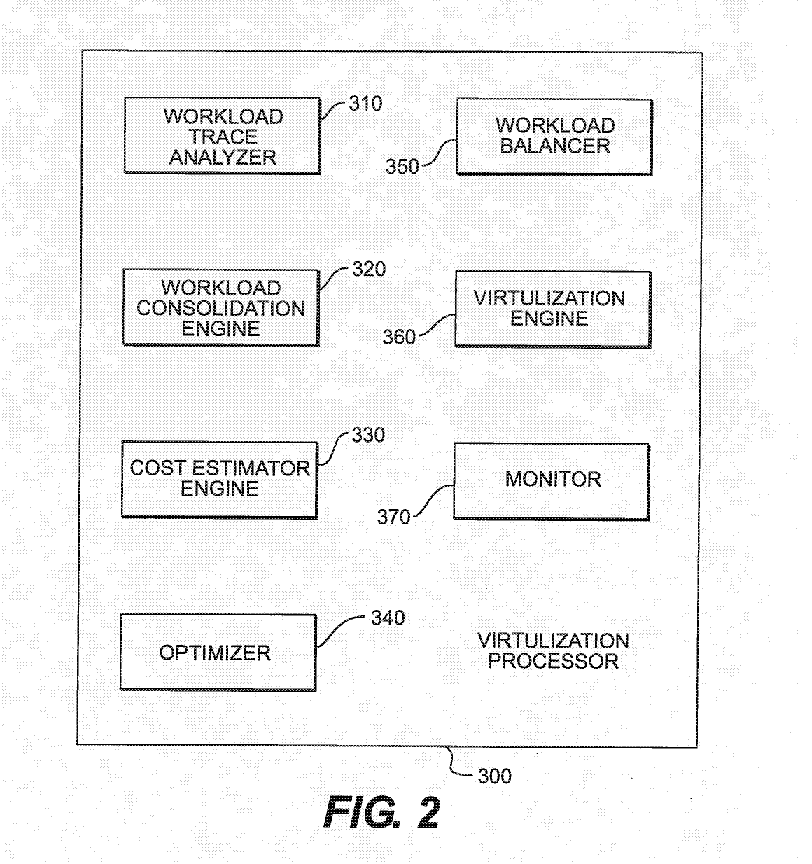

FIG. 2 illustrates an embodiment of the virtualization processor system 300, which is usable in the environment of FIG. 1, to generate, monitor, and manage virtualization alternatives for hosting client workloads. In FIG. 2, the virtualization processor system 300 includes workload trace analyzer 310, workload consolidation engine 320, cost estimator engine 330, optimizer 340, workload balancer 350, virtualization engine 360, and monitor 370. The computer code or machine instructions representing the virtualization processor system 300 may be stored in the data store 130.

The workload trace analyzer 310 evaluates a pattern of resource demands of a workload to determine whether the pattern accurately represents actual demands. In one aspect, the analyzer 310 identifies a metric that indicates how well the pattern represents the resource demands of the workload. A representative workload trace may reflect resource demands of a workload over a period of time, such as over a six-month period. A representative workload trace may, in some instances, be derived from an actual historical workload of resource demands observed during operation of the cloud service 100. The patterns may be cyclic, repeating patterns o resource demands such as hourly, daily, weekly, or monthly, for example.

Once the analyzer 310 determines that the pattern accurately reflects the workload's resource demands, the pattern may be used in performing further capacity planning analysis. For instance, occurrences of a pattern identified in a representative workload may be analyzed to detect a trend of the resource demands (e.g., whether increasing, decreasing, etc.), and such a trend may be taken into account in predicting future resource demands of the workload.

The consolidation engine 320 determines appropriate workload distributions among the cloud service processing system 140 resources while minimizing the number of resources used for hosting the workloads. The consolidation engine 320 operates to assign as many workloads as possible to as few physical machines as possible. If for each capacity attribute for both the workloads and the virtual machines, e.g. CPU and memory, the peak demand is less than the capacity of the attribute for the physical machine, then the workloads fit on the physical machine.

The cost estimator engine 330 determines the cost of various workload/host configurations. In a first aspect, the cost estimator engine 330 provides cost estimates based on actual historical records of processing and memory demand, and power usage. In this firs aspect, the cost estimator engine 330 traverses per-workload historical time varying traces of demand to determine the peak of the aggregate demand for the combined workloads. In a second aspect, the cost estimator engine 330 provides cost estimates based on hypothetical or expected demand and usage. In this second aspect, the cost estimator engine 330 emulates the assignment of several workloads on a single physical machine or on multiple physical machines.

In an example, the cost estimator engine 330 includes programming that considers the total costs of the resource pool to include acquisition costs for facilities, physical information technology equipment and software, power costs for operating machines and facilities, and administrative costs. However, in an example, the cost estimator engine 330 considers only the costs of the physical machines (servers) and virtualization software licensing costs. Acquisition costs may be spread over time, such as three years, and are recovered according to an assumed rate for each costing interval. A server's costs may be broken down by the resources it provides, such as CPU and memory. Some server costs, such as CPU and memory, can be mapped directly to a workload. Other server costs, such as the power supply, are not directly considered, but may be assigned in proportion to the assigned direct costs. In an example, the cost estimator engine 330 assigns licensing costs as CPU or memory costs. In another example, the cost estimator engine 330 divides licensing costs equally across CPU and memory demands in proportion to the CPU and memory costs. In these examples, the cost estimator engine 330 may consider three usage categories for each resource (e.g., for each CPU and memory): direct consumption by a workload, burstiness, and unallocated or excess resource capacity. Direct resource consumption may represent the average physical utilization of a server by a workload. Further, direct resource consumption is zero if a workload does not use a server. In an example, burstiness may represent the difference between peak utilization of a server by a workload and its average utilization. In this example, unallocated resources represent the difference between 100 percent use and the peak utilization of the server. In another example, burstiness may represent the difference between a high percentage of utilization of a server and an average utilization. In this example, unallocated resources represent the difference between 100 percent use and the high utilization for a server. In these examples, corresponding costs over all resources in a resource pool may be summed to give a total cost for each costing interval, considering that the three cost types, direct, burstiness, and unallocated, sum to 100 percent of the costs.

The optimizer 340 examines many alternative placements of workloads on servers and reports the best solution(s) found. In an embodiment, the optimizer 340 executes a recursive process that considers costs, CPU and memory demands, and power demands for the alternate placements that are available in the cloud service 100. The optimizer 340 may be applied for workload placement plans that last for a short time, e.g., minutes or hours, or a longer time, e.g., weeks or months.

The workload balancer 350 levels workloads across a set of resources to reduce the likelihood of service level violations. The workload balancer 350 may be used between invocations of the optimizer 340 both during planning and during real time workload execution and management The workload balancer 350 may provide further refinements to the placement decisions of the consolidation engine 320. The workload balancer 350 also may provide dynamic adjustment recommendations during workload execution. The workload balancer 350 provides controlled overbooking of capacity and is capable of supporting a different quality of service (QoS) for each workload. The workload balancer 350 may use as an input, the highest quality of service, that corresponds to a required capacity for workloads on a server that is the peak of the workloads' aggregate demand.

The above elements of the system 300 cooperate to generate one, or more than one, workload placement plans, with one of the workload placement plans implemented automatically or upon direction of a system administrator.

The virtualization engine 360 is used to assign workloads to virtual machines and physical machines. In one embodiment, virtualization engine 360 executes a workload placement plan as generated by other elements of the system 300 upon approval and direction of a system administrator. In another embodiment, the virtualization engine 360 automatically selects a workload placement plan. If the system generates multiple workload placement plans, the virtualization engine 360 may choose a plan according to some pre-established criteria, such as lowest aggregate cost, highest aggregate QoS, and similar criteria.

The workload monitor 370 collects CPU and memory usage, and power usage from the physical machines and virtual machines, as used by the assigned workloads.

The system and method provide a workload placement plan that includes a best cost or price point for each workload, a best average effective cost for each workload, and a best “right-virtualization” plan for all the workloads. The system and method also consider power consumption. As an example, assume that the processing system 140 includes the two physical machines 150 and 160 with the virtual machines 152, 154, 156, 162, and 164, and each virtual machine can provide 20 processing and memory units. Assume further that the sum of the peaks of the processing and memory demands of the workloads is 100 units, but the average demand is 20 units (a bursty workload scenario). In this scenario, where some of the workloads are very bursty, all five virtual machines may be needed to service the workloads, with costs apportioned evenly across workloads, the effective cost would be 5 (peak of 100 divided by average of 20). However, if the sum of the peaks is 40, then only two virtual machines would be required, and the effective cost would be 2. This simple example points out how the excess cost associated with unused capacity can inflate the effective cost of using the cloud service 100. One goal, therefore, of the disclosed system and method is to consolidate as many workloads as possible, considering quality of service requirements, onto as few physical machines as possible. One aspect of this goal is to identify workloads that may best be serviced on lower cost virtual machines or directly on physical machines. Although perhaps counter-intuitive, this aspect of the goal may lead to very bursty workloads being serviced on physical machines. For example, some virtualization software and programs may exceed the cost of a physical machine. In addition, some workloads may require an entire physical machine, or a large portion of a physical machine, to provide the desired QoS. In this situation, the workload could be executed directly on a physical machine and thereby avoid the high cost of virtualization software. Another aspect of the goal is to allocate costs for unused capacity to those workloads whose demands result in the unused capacity. Specifically, and as discussed herein, bursty workloads tend to drive the need for more hardware and software to accommodate their bursty periods. When the workloads are more quiescent, the overall demand on the processing system 140 falls, but the overall capacity remains, resulting in unused capacity. In this example, the cost of this unused capacity then is allocated to the bursty workloads based on their proportional share in the excess.

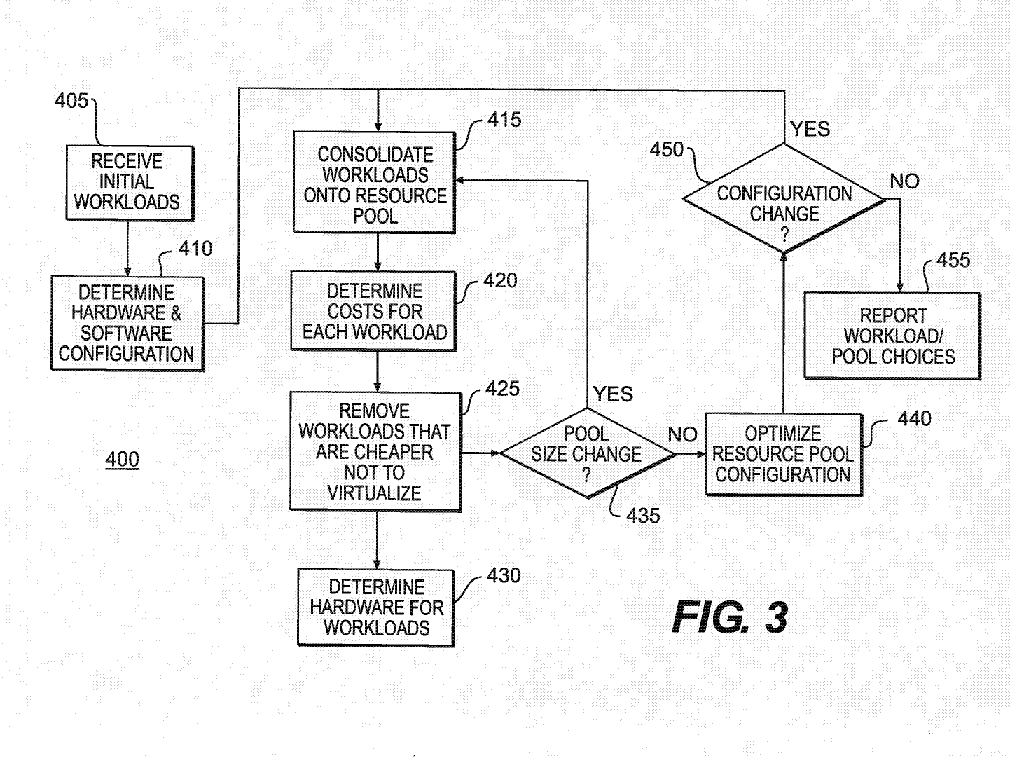

FIG. 3 is a flow chart illustrating an embodiment of a method for assigning workloads in the environment 10 of FIG. 1. The method may be used in a number of scenarios, including in support of hardware and software acquisition for a resource pool system such as the private cloud service 100 of FIG. 1. Similarly, the method may be used for initial assignment of workloads among the resources of the cloud service 100; when workloads change, including addition and deletion of workloads, and changes to workload definitions; when hardware or software updates (e.g., new server models, new virtualization software) are received and implemented; when hardware and software fail, including by power loss; and periodically (e.g., one per calendar quarter, daily). The data inputs to the method include workload definitions, including the processing and memory demands of each workload, server power consumption, the amount of “burstiness” of each workload, quality of service (QoS) requirements of each workload, cost or price limits that may be specified for each workload, workload priority, and the hardware and software configurations of the cloud service processing system 140. Data related to the workloads may be based on historic performance of the workloads, where the cloud service 100 includes monitoring features (e.g., the monitor 370 of FIG. 2) to record and subsequently analyze executing workload traces. Such monitoring may capture CPU processing and memory demands on a frequent basis, such as once every minute. Data related to the workloads also may be estimates of what the workloads may demand in terms of CPU time and memory, and server power consumption. The method computes interim results including the estimated costs to host each workload for specific resource configurations. The output of the method includes a report with suggested assignments of workloads to physical machines, and assignment of workloads to virtual machines, including assignment to virtual machines having lower cost virtualization software. A system administrator may use the report to configure or reconfigure hardware and software and the assignment of workloads to the resources of the private cloud service 100. Alternately, the virtualization engine 360 may automatically configure or reconfigure hardware and software and he assignment of workloads.

In FIG. 3, virtualization method 400 includes three phases: determining a desirable host configuration for the resource pool (i.e., the cloud infrastructure 140) of the cloud service 100 estimating costs based on the desirable host configuration and “right-virtualizing” workloads based on the cost estimates, and monitoring usage over time and adjusting the resource allocations. The method 400 begins in block 405 when the virtualization processor system 300 determines an initial set of workloads to host at the cloud service 100. In block 410, the system 300 determines one or more possible hardware and software configurations for the infrastructure 140. That is, the system 300 determines how to configure virtual machines among the physical machines 150 and 160. These physical machines 150 and 160 represent a certain processing capacity in terms of CPU cores and memory. The system 300 assigns workloads and virtual machines to physical machines. A workload can be associated with one or more virtual machine. A workload can be associated with more than one virtual machine if the workload has for example, multiple logical application servers that are expected to run (in virtual machines) on separate physical servers whether for performance or reliability reasons, for example. In block 415, the consolidation engine 320 packs the workloads onto a small number of physical machines. The assignment of workloads takes into account the aggregate time-varying (multiple) resource usage of the workloads and a given capacity of the host physical machines.

In block 420, the cost estimator engine 330 determines costs for each workload as they would be hosted on the resources of the cloud service processing system 140. Costs may be apportioned among the hosted workloads considering the burstiness of the workload, for example. The costs then can be compared to costs of other alternatives. For example, moving a workload from the cloud service 100 to an alternate public or private cloud service may incur lower costs than hosting the workload at the cloud service 100. Alternately, a workload may incur lower costs if moved to a dedicated physical machine because the additional virtualization software costs may constitute a significant fraction of the overall workload cost, especially for large or very bursty workloads. For workloads whose runtime costs on a virtual machine are predicted to exceed those on a physical machine, the workloads are removed, block 425, from a list of workloads that will be virtualized. In addition, in block 425, if the cost associated with a workload is greater than the cost for the workload on a server hosting a less costly virtual machine (for example, a physical machine/virtual machine combination outside the shared resource pool) that could also host the workload, then the workload may be a candidate for right-virtualizing. The method can be repeated for different combinations of resource pool host and outside resource pool host configurations. Following block 425, if any workloads are identified for non-virtualization, the system 300, in block 430, determines which hardware resources of the cloud service processing system 140 are available. Similarly, the system 300 may recommend moving a specific workload to a lower cost virtualization solution, including moving the workload to another cloud service such as a public cloud service.

Following the analysis of block 425, the method 400 also moves to block 435, and the virtualization processor system 300 determines if the resource pool size changed, which could happen if a workload is moved to another cloud service or to a physical machine of the cloud service 100. If, in block 435, the pool size has been determined to have changed, the method 400 returns to block 415. If, however, in block 435, the pool size has been determined not to have changed, the method 400 moves to block 440.

In block 440, the optimizer 340 generates an optimum resource pool configuration: one in which, for example, the average resource usage in the pool for the selected host configuration is balanced and well utilized. For example, if host memory is often less than 50 percent utilized, the desired memory size for the hosts physical machines may be reduced, and the method steps of blocks 415 to 425 repeated. This desired memory reduction can be useful when the cloud service 100 is adding new hardware and/or when different physical machines are available from the resource pool. In block 450, the virtualization processor system 300 determines if the just-generated pool resource configuration should be changed. If, in block 450, a change is indicated, the method 400 returns to block 415. If no change is indicated, the method 400 moves to block 455 and the virtualization program generates a workload/resource pool configuration report that may be viewable by a system administrator.

The effectiveness of the virtualization processor system 300 can be demonstrated by the results of an exercise in which three-month traces of workload monitoring data (CPU and memory) for 312 workloads are analyzed. In this exercise a shared resource pool is configured with servers having 24×2.2-GHz processor cores and 96 GB of memory each. A hardware configuration is chosen such that after consolidation, the peak utilization of CPU and memory was balanced for the servers. The acquisition cost for each server is estimated as approximately $23,000, including virtualization platform licensing and support costs of about $9,800 for a commercial virtualization program. CPU capacity and CPU demand are defined in units of CPU shares (100 shares correspond to one 1 GHz CPU), and memory usage is measured in GB.

The consolidation engine 320 minimizes the number of servers needed to host the set of workloads while satisfying their time varying resource demands. Consolidating all workloads into virtual machines requires a resource pool of 31 servers with a total cost of about $741,440 for a 3-year lifetime including estimated power costs of about $27,580 ($0.1 $/KWh). Apportioning the costs across hosted workloads reveals that 22 workloads are candidates for right-virtualizing. These 22 workloads are assigned to lower cost servers that each have two 8 core CPUs with 2.4 GHz and 72 GB of memory. Assuming no additional costs for virtualization, by this “right-virtualizing,” the cost for the customer decreases by about $77,660 (by 12%), with hardware acquisition costs increasing to about $453,470 (by 10%) while virtualization costs decrease to about $176,470 (by 42%).

Since workloads with high memory demands now hosted outside the pool, the memory size of the resource, pool nodes can be reduced to 48 GB (the optimized memory of resource pool) without affecting the number of workloads that can be hosted This leads to the additional hardware savings of about $49,750 for the customer and results in 18.4% of total costs savings, mostly due to lower virtualization licensing costs.

Finally, the cost of increased power demand for the optimized solution is included in the model. Power represents a small fraction of total cost, for the considered servers. Large, high-end servers are often used for consolidation and are very power-efficient in this context. For less power efficient and less expensive servers, power will represent a larger fraction of total cost. However, the increase in power costs for operating a few more servers is expected to be much smaller than the savings.

We claim:

1. A method for automated virtualization of workloads, comprising:
receiving identities of workloads to be considered for assignment to a shared resource pool;
determining hardware configurations to support the workloads, the hardware configurations including a plurality of available physical machines;
using the determined >hardware configurations, consolidating the workloads among virtual machines hosted on the available physical machines;
determining costs associated with running each of the workloads on a virtual machine and on a physical machine; and
if the cost of running a workload on a virtual machine exceeds the cost of running the workload on a physical machine, removing the workload from consideration for assignment to the shared resource pool.

2. The method of claim 1, further comprising:
upon removing the workload from consideration for assignment to the shared resource pool, assigning the workload to an alternate virtual machine outside the shared resource pool.

3. The method of claim 2, wherein the virtual machine outside the shared resource pool comprises a virtual machine hosted at a computing site, different from the computing site of the shared resource pool.

4. The method of claim 3, wherein in the different computing site is a public cloud.

5. The method of claim 2, wherein the virtual machine outside the shared resource pool comprises a virtual machine having a reduced cost virtualization program.

6. The method of claim 1, further comprising:
upon removing the workload from consideration for assignment to the shared resource pool, assigning the workload to a physical machine outside the shared resource pool.

7. The method of claim 1, further comprising:
upon removing the workload from consideration for assignment to the shared resource pool, determining if a size of available resources in the shared resource pool has changed;
if the size of available resources has changed, re-consolidating the workloads among the virtual machines; and
if the size of available resources has not changed, determining an optimum resource pool configuration.

8. The method of claim 7, wherein determining an, optimum resource pool configuration comprises:
balancing workloads among virtual machines; and
ensuring computing resources are used at least at a predetermined threshold.

9. The method of claim 8, further comprising generating a report of the optimum resource pool configuration.

10. A method for optimizing distribution of workloads over a set of shared resources, comprising;
identifying workloads to be distributed over the set of shared resources;
determining hardware configurations to support the workloads, the hardware configurations including a plurality of available physical machines, the available physical machines hosting virtual machines;
using a determined hardware configuration of the available physical machines, assigning the workloads among the virtual machines hosted on the available physical machines to produce a configuration of consolidated workloads and a configuration of virtual machines and physical machines;
using the configuration of consolidated workloads, determining costs associated with running each of the workloads on its assigned virtual machine; and
if the cost of running a workload on a virtual machine exceeds the cost of running the workload on a physical machine, removing the workload from the configuration of virtual machines.

11. The method of claim 10, further comprising:
upon removing the workload from the configuration of virtual machines, assigning the workload to an alternate virtual machine outside the configuration of virtual machines.

12. The method of claim 11, wherein the virtual machine outside the configuration of virtual machines comprises a virtual machine hosted on a computing site different from a computing site of the set of shared resources.

13. The method of claim 12, wherein the computing site of the set of shared resources is a private cloud and the different computing site is a public cloud.

14. The method of claim 11, wherein the virtual machine outside the configuration of virtual machines comprises a virtual machine having a reduced cost virtualization program.

15. The method of claim 10, further comprising:
upon removing the workload from the configuration of virtual machines, assigning the workload to execute directly on a physical machine.

16. A computer-readable storage medium encoded with a computer program, the program comprising instructions that, when executed by a processor, causes the processor to:
identify workloads that are to be considered for hosting in a shared resource environment;
determine hardware configurations to support the workloads, the hardware configurations including a plurality of available physical machines, the available physical machines hosting virtual machines;
using a determined hardware configuration of the available physical machines, assign the workloads among the virtual machines hosted on the available physical machines to produce a configuration of consolidated workloads and a configuration of virtual machines;
using the configuration of virtual machines, determine costs associated with running each of the workloads on its assigned virtual machine; and
if the cost of running a workload on a virtual machine exceeds the cost of running the workload on a physical machine, remove the workload from the configuration of virtual machines.

17. The computer-readable storage medium of claim 16, wherein the processor assigns the removed workload to one of a virtual machine outside the configuration of virtual machines and a physical machine.

18. The computer-readable storage medium of claim 16, wherein the processor assigns remaining workloads among the virtual machines.

19. The computer-readable storage medium of claim 17, wherein the virtual machine outside the configuration of virtual machines is at a computing site different from a site of the shared resources.

20. The computer-readable storage medium of claim 16, wherein the processor:
generates a configuration report of the configuration of consolidated workloads, the configuration of virtual machines and removed workloads; and
receives and executes directions to implement the configuration report.
